(19) United States
(12) Patent Application Publication
(10) Pub. No.: US 2025/0052979 A1
(43) Pub. Date: Feb. 13, 2025

(54) SURFACE SENSING IN AUTOMATED SAMPLE ANALYSIS

(71) Applicant: Akoya Biosciences, Inc., Menlo Park, CA (US)

(72) Inventors: Peter J. Miller, Cambridge, MA (US); Carla Coltharp, Waltham, MA (US)

(21) Appl. No.: 18/717,652

(22) PCT Filed: Dec. 12, 2022
(86) PCT No.: PCT/US22/52531

§ 371 Date: Jun. 7, 2024

Related U.S. Application Data
(60) Provisional application No. 63/288,515, filed on Dec. 10, 2021.

(51) Int. Cl. G02B 7/28; G02B 21/06; G02B 21/24

(52) U.S. Cl. CPC G02B 7/28; G02B 21/06; G02B 21/244

(57) ABSTRACT

Methods include generating a modulated light pattern using a light modulator (108), transmitting the modulated light pattern through an objective lens (104) to a surface of a substrate (150), where the objective lens (104) defines an object plane, obtaining a plurality of images of the modulated light pattern reflected from the surface of a substrate (150), where each modulated light pattern is obtained at a different relative distance between the objective lens (104) and the substrate surface, analyzing the plurality of images to determine a reference location of the substrate surface relative to the objective lens (104) that corresponds to positioning of an image of the modulated light pattern formed by the objective lens (104) at the object plane, and adjusting a position of the substrate (150) relative to the objective lens (104) based on the reference location.

### CROSS-REFERENCE TO RELATED APPLICATIONS

This application claims priority to U.S. Provisional Patent Application No. 63/288,515, filed on Dec. 10, 2021, the entire contents of which are incorporated herein by reference.

### TECHNICAL FIELD

This disclosure relates to optical microscopy, automated sample processing and imaging systems, and sensing mounted samples.

### BACKGROUND

Automated slide scanning systems are used for analysis of mounted samples. In particular, such systems are used for digitizing, archiving, and sharing images of samples. By acquiring and storing digital images, the images can be retrieved and analyzed by technicians (or by automated analysis systems) to grade or classify the samples, and also to identify disease conditions specific to particular samples.

### SUMMARY

This disclosure features methods and systems for sensing surfaces in optical microscopes, automated slide scanning systems featuring such microscopes, and other optical inspection systems. For example, in slide scanning systems, a sample (e.g., a tissue sample) is typically immobilized on the surface of a microscope slide, and a coverslip is applied atop the mounted sample. Automated slide scanning systems attempt to locate the sample on the surface of the slide. Determining the position of the coverslip surface relative to the object plane of the optical microscope system used for imaging the sample is an important first step in this process, as it helps to reduce the complexity (i.e., the dimensionality) of the search process.

The methods and systems disclosed herein are typically performed before any images of the sample are obtained. Thus, the methods and systems effectively “re-use” the optical pathways and imaging components, first for determining the coverslip position, and then for acquiring images of the sample. Relative to other systems which include a second imaging system dedicated to “range finding”, the systems disclosed herein are less complex and typically involve fewer components. Furthermore, because coverslip location and/or orientation is determined prior to imaging the sample, high quality images can be obtained without iteration during imaging to determine the position of the coverslip relative to the imaging system's object plane.

To determine the relative position of the coverslip and object plane of the imaging system, a two-dimensional pattern of light is projected onto the surface of the coverslip, and an image of the light pattern reflected from the coverslip surface is analyzed to determine the coverslip position relative to the object plane of the imaging system. By obtaining images of the pattern corresponding to different distances between a pattern-generating optical element and the object plane of the imaging system and analyzing the images, the relative position of the coverslip and the object plane can be determined.

Measuring the coverslip location in this manner can yield a number of important advantages. By accurately locating the surface of the coverslip, subsequent scanning operations to locate tissue of interest can be performed much more rapidly and accurately, leading to reduced imaging/processing times. This can be particularly important for samples that are imaged in fluorescence mode, as finding tissue can be time consuming and prone to confounding imaging artifacts arising from dust and other debris on the coverslip and slide surfaces. The methods can be performed at multiple locations on the surface of a coverslip to determine whether the coverslip surface (i.e., the surface height) varies across the sample; appropriate corrections can then be applied to ensure that the coverslip surface geometry is accounted for during subsequent slide scanning to locate tissue of interest. The methods can be performed rapidly, and sensing of the coverslip surface does not depend on (and nominally, is not influenced by) the nature of the sample. Thus, the process of locating the surface is independent of the tissue or other material that forms the sample, and can be performed in fully automated fashion.

In one aspect, the disclosure features methods that include: generating a modulated light pattern using a light modulator; transmitting the modulated light pattern through an objective lens to a surface of a substrate, where the objective lens defines an object plane; obtaining a plurality of images of the modulated light pattern reflected from a surface of a substrate, where each modulated light pattern is obtained at a different relative distance between the objective lens and the substrate surface; analyzing the plurality of images to determine a reference location of the substrate surface relative to the objective lens that corresponds to positioning of an image of the modulated light pattern formed by the objective lens at the object plane; and adjusting a position of the substrate relative to the objective lens based on the reference location.

Embodiments of the methods can include any one or more of the following features.

The substrate can include a coverslip that overlies a biological sample. The substrate can include a slide that supports a biological sample. The biological sample can include a tissue section.

Generating the modulated light pattern can include generating illumination light and transmitting illumination light through the light modulator. The light modulator can be a passive modulator. The light modulator can be an active modulator. The passive modulator can include a reticle.

Each of the plurality of images can be obtained by a detector positioned at an image plane that is conjugate to the object plane. The objective lens cam be an infinite-conjugate objective lens.

Analyzing the plurality of images can include identifying an image among the plurality of images in which the modulated light pattern is in best focus. Determining the reference location can include identifying as the reference location a location of the substrate surface relative to the objective lens for which the identified image was obtained.

Analyzing the plurality of images can include identifying two or more images among the plurality of images in which the modulated light pattern is in best focus, and determining the reference location can include interpolating between locations of the substrate surface relative to the objective lens for which the identified images were obtained.

Adjusting a position of the substrate can include adjusting the substrate position so that a biological sample positioned below or atop the substrate is located in the object plane.

The methods can include obtaining one or more images of the biological sample with the biological sample located in the object plane.

Embodiments of the methods can also include any of the other features described herein, including combinations of features individually described in connection with different embodiments, except as expressly stated otherwise.

In another aspect, the disclosure features systems that include an illumination source, an objective lens, a light modulator, a detector, a stage, and a controller connected to the illumination source, the detector, and the stage, where the objective lens defines an object plane of the system, and where the controller is configured to: activate the illumination source to generate illumination light and direct the illumination light to the light modulator to generate a modulated light pattern; activate the stage to position a surface of a substrate on the stage at a plurality of different distances relative to the objective lens; activate the detector to obtain images of the modulated light pattern at the detector corresponding to each of the plurality of different distances; analyze the images to determine a reference location of the substrate surface relative to the objective lens that corresponds to positioning of an image of the modulated light pattern formed by the objective lens at the object plane; and activate the stage to adjust a position of the substrate relative to the objective lens based on the reference location.

Embodiments of the systems can include any one or more of the following features.

The substrate can include a coverslip that overlies a biological sample. The substrate can include a slide that supports a biological sample. The biological sample can include a tissue section.

The light modulator can be a passive modulator. The light modulator can be an active modulator. The passive modulator can be a reticle.

The detector can be positioned at an image plane of the system. The image plane cam be conjugate to the object plane. The objective lens can be an infinite-conjugate objective lens.

The controller can be configured to analyze the images by identifying an image among the images in which the modulated light pattern is in best focus. The controller cam be configured to determine the reference location as a location of the substrate surface relative to the objective lens for which the identified image was obtained.

The controller can be configured to analyze the images by identifying two or more images among the images in which the modulated light pattern is in best focus, and to determine the reference location by interpolating between locations of the substrate surface relative to the objective lens for which the identified images were obtained.

The controller can be configured to activate the stage to adjust the position of the substrate so that a biological sample positioned below or atop the substrate is located in the object plane. The controller can be configured to activate the detector to obtain one or more images of the biological sample with the biological sample located in the object plane.

Embodiments of the systems can also include any of the other features described herein, including combinations of features individually described in connection with different embodiments, except as expressly stated otherwise.

As used herein, a “coverslip” is a member that is used atop a sample (e.g., tissue and/or other biological material) mounted or fixed to a microscope slide or other support. Coverslips can be formed from a wide variety of materials including, but not limited to, glasses, plastics, polymers, and quartz, and other transparent and semi-transparent materials. In general, coverslips can be translucent or opaque at one or more wavelengths of light, and are at least partially reflective of incident light.

Unless otherwise defined, all technical and scientific terms used herein have the same meaning as commonly understood by one of ordinary skill in the art to which this disclosure belongs. Although methods and materials similar or equivalent to those described herein can be used in the practice or testing of the subject matter herein, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

In general, method steps described herein and in the claims can be performed in any order, except where expressly prohibited or logically inconsistent. It should be noted that describing steps in a particular order does not mean that such steps must be performed in the described order. Moreover, the labeling of steps with identifiers does not impose an order on the steps, or imply that the steps must be performed in a certain sequence. To the contrary, the steps disclosed herein can generally be performed in any order except where noted otherwise.

The details of one or more embodiments are set forth in the accompanying drawings and the description below. Other features and advantages will be apparent from the description, drawings, and claims.

### DESCRIPTION OF DRAWINGS

FIG. 1 is a schematic diagram of an example of an optical microscope system.

FIG. 2 is a schematic diagram of the optical microscope system of FIG. 1 with certain additional elements replaced.

FIG. 3 is a flow chart showing a set of example steps for performing a calibration of the optical microscope system of FIG. 1.

FIG. 4 is a schematic diagram of an example controller.

Like reference symbols in the various drawings indicate like elements.

### DETAILED DESCRIPTION

### Introduction

Automated optical microscopes and slide scanning systems typically perform analyses of slide-mounted samples by locating tissue of interest on the slide, and then obtaining and analyzing detailed tissue images to extract a variety of qualitative and quantitative information, enabling one to perform tissue classification. Locating tissue of interest generally involves both finding the tissue and determining the position of the tissue relative to the microscope imaging system's object plane.

For slide-mounted samples that are imaged in brightfield imaging modes (i.e., absorption or transmission modes, for example), tissue of interest can be located relatively easily with a moderate depth of focus, even when the tissue is not located at the system's object plane. Once the tissue is located in the plane of the slide, the displacement of the tissue from the system's object plane can be determined in a straightforward manner using methods such as interpolation between focused measurements at different “heights” (i.e., object plane positions) orthogonal to the nominal surface of the slide.

Locating tissue of interest can be more difficult in samples that are prepared for and imaged in darkfield imaging modes such as fluorescence emission, however. In these imaging modes, locating the tissue extent can be more difficult due to the relatively weaker optical imaging signals. Thus, if integration times are too short during sample imaging, not enough light intensity is collected to accurately locate the tissue. Conversely, if integration times are too long, the collected light intensity can saturate the detector.

Locating tissue of interest in darkfield imaging modes is therefore a complex 5-dimensional problem, involving exploration of 3 spatial coordinates (e.g., x-, y-, and z-dimensions) as well as a spectral coordinate (i.e., the wavelength of illumination or detection) and a time coordinate. Along the spectral coordinate, tissue of interest may not be uniformly stained with a dye or stain that provides a measurable signal at the selected wavelength of illumination or detection. Along the time coordinate, as discussed above, underexposure of the sample may yield weak or unmeasurable signals, while overexposure may saturate the detector.

Further, confounding effects due to imaging artifacts that arise from dust, excess fluorescent dye, and other debris on sample and/or other surfaces (e.g., surfaces of slides and coverslips) are typically greater in darkfield imaging modes; dust in particular can fluoresce strongly at certain wavelengths, obscuring underlying tissue and making localization challenging. Because dust is not always coplanar with the sample, and can be located on coverslip surfaces and/or slide surfaces, strategies that mistake dust for the sample can yield erroneous results.

A certain amount of variability is also introduced by the sample height and by the slide profile. Samples in general are of irregular height, and thus, the upper surface of the sample (i.e., the surface closest to the objective lens) is not consistently located relative to the object plane from sample to sample.

Furthermore, individual slides can vary in thickness. For example, individual microscope slides can have a nominal thickness of approximately 1 mm, but may actually be between 0.9 mm and 1.1 mm thick; the variation in thickness can therefore be as much or greater than the thickness of the sample on the slide.

In addition, individual slides do not always register perfectly against the support structure (e.g., a microscope stage) in an imaging system. Slide-to-slide variations in the position of the slide relative to the support structure also result in variations of the position of the slide relative to the system's object plane.

Typically, a sample (e.g., a tissue or other biological sample) is mounted or affixed to the surface of a slide, and then a coverslip is applied atop the mounted sample. Coverslips that are used atop sample in this manner have relatively consistent thicknesses. Thus, the location of a sample relative to the system's object plane can be determined by measuring the location of the coverslip relative to the object plane, and more specifically, the location of the coverslip's upper surface (i.e., the surface on the opposite side from the surface that contacts the sample).

Thus, for illustrative purposes, the following discussion will focus on methods and systems for determining the location of the upper surface of the coverslip (referred to simply as the “surface of the coverslip”) relative to the system's object plane. However, it should be understood that the methods and systems disclosed herein can also be applied to determine the locations of other surfaces relative to the object plane. For example, where samples flow through or are disposed in channels in a microfluidic substrate (i.e., a chip), the methods and systems disclosed herein can be used to determine the location of a surface of the microfluidic substrate. Thus, it should be understood that the following discussion is provided for explanation, and is not restricted only to determining the location of the surface of a coverslip.

In some alternative surface-locating methods, complex optical systems involving separate optical pathways for surface-locating light and imaging light are used. Separate optical components for each pathway are used. In certain methods, unusual detection geometries involving tilted detectors (i.e., tilted relative to the propagation direction of surface-locating light) are employed. In addition, some methods involve real-time monitoring of a surface as the surface is simultaneously imaged, and require that any deviations from ideal imaging conditions can be detected rapidly and at high resolution. These systems therefore tend to be costly and complex, with a relative large number of components.

In contrast, the methods and systems disclosed herein effectively re-use the optical imaging pathway in a microscope system to locate the sample relative to the system's object plane, and then to image the sample once it is properly positioned. That is, sample locating and sample imaging are performed in time sequential fashion rather than simultaneously. Because nearly all of the optical components of the system are used for both functions, the complexity of the optical configuration is significantly reduced relative to conventional systems.

### Optical Microscope Systems

In general, the methods disclosed herein are implemented after a slide-mounted sample has been introduced into the system and before high magnification images of the sample are acquired for archiving and analysis. High magnification sample imaging, e.g., for digital pathology, is greatly aided by first locating the sample to be imaged relative to the object plane of the imaging system. As will be discussed in greater detail below, the surface of a coverslip overlying the mounted sample is first located by directing a two-dimension light pattern onto the coverslip surface at relatively low optical power. From an image of the reflected pattern from the surface of the coverslip, a system offset is calculated and applied to the sample so that the sample is located in, or close to, the system's object plane (i.e., the sample is located at a position that is within 20 microns of the system's object plane, such as within 10 microns, or within 5 microns, of the object plane).

The sample is then translated in a plane parallel to the object plane and imaged to facilitate finding tissue of interest on the surface of the slide. Sample imaging at this stage can be performed either at low optical power (as for the determination of the coverslip location) or at high optical power. The sample images are analyzed to identify tissue of interest and the tissue coordinates along all three coordinate directions are stored.

Prior to obtaining detailed, high resolution sample images, the system can optionally perform a fine focus adjustment procedure. In this procedure, the system can determine an optimum focus position at a few different locations on the sample, thereby constructing a focus map for subsequent high resolution imaging.

The system then re-uses the same optical components—after switching out the low power objective lens for a high power objective lens, if this has not already occurred—to obtain high resolution images of the identified tissue of interest for use in digital pathology. Each of the foregoing steps is repeated without adjusting the position or orientation of the detector, along the same optical pathway to and from the sample, and with a relatively small number of adjustments to the system's optical components. By re-using system components and pathways in this manner, the sample can be reliably positioned within the system's object plane for imaging purposes, while at the same time significantly reducing the complexity of the system relative to conventional systems surface-finding systems.

Thus, the steps of locating and positioning the sample relative to the object plane, finding tissue of interest at different locations within a plane parallel to the object plane, and obtaining high magnification images of the tissue of interest once it has been found and properly positioned, are all performed in temporal sequence. The sequential nature of these operations allows various components of the imaging system to be used for different purposes at different points in time, with very little re-configuration of the system from one step to the next. Furthermore, although the operations are performed sequentially in time, the steps of locating and positioning the sample in the object plane and finding tissue of interest can be performed relatively rapidly so that despite the sequential nature of the operations, high resolution sample images can be obtained relatively rapidly under favorable imaging conditions.

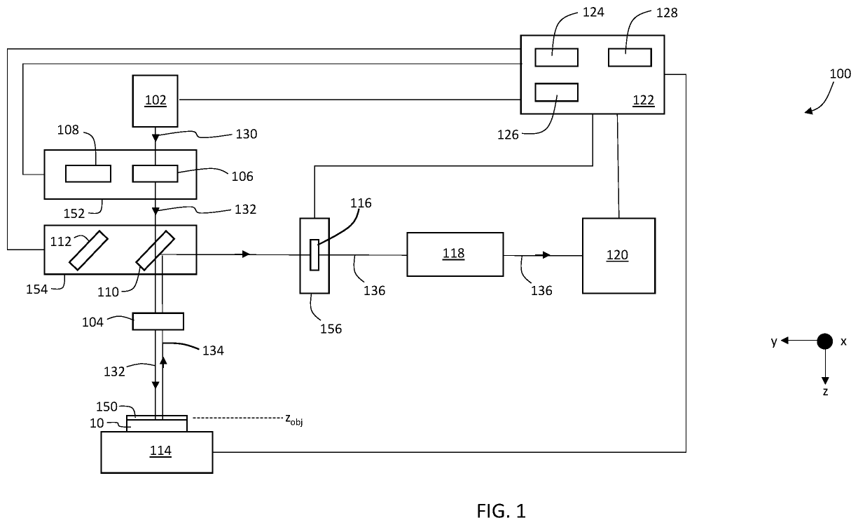

FIG. 1 shows a schematic diagram of an example of an optical microscope system 100. System 100 can be a stand-alone microscope system, or can be integrated into a larger system such as an automated slide scanning system. System 100 includes an illumination source 102, an objective lens 104, an excitation filter assembly 152, a beamsplitter assembly 154, an emission filter assembly 156, a stage 114, an imaging lens 118, a detector 120, and a controller 122. Excitation filter assembly 152, beamsplitter assembly 154, emission filter assembly 156, stage 114, and detector 120 are electrically connected to, and in communication with, controller 122. Controller 122 includes a display interface 124, an input interface 126, and one or more electronic processors 128.

Stage 114 supports a sample 10, which typically includes a specimen mounted on a substrate, with a coverslip positioned atop the specimen such that the specimen is sandwiched between the substrate and the coverslip.

During operation in which system 100 is configured to obtain an image of sample 10, illumination source 102 generates illumination light 130 which propagates along the z-direction of the rectangular coordinate system shown in FIG. 1, passes through objective lens 104, and is incident on excitation filter assembly 152. Excitation filter assembly includes one or more excitation filters 106, and controller 122 can selectively position a desired excitation filter 106 or combination of filters 106 in the path of illumination light 130 by transmitting a suitable control signal to excitation filter assembly 152, to generate filtered light 132. It should be noted that the use of an excitation filter or combination of excitation filters is optional, and in some embodiments, illumination light 130 does not pass through any excitation filters. To that end, “filtered light 132” can be understood to refer either to illumination light 130 that has passed through one or more excitation filters 106, or alternatively, to illumination light 130 that has passed through a region between objective lens 104 and beamsplitter assembly 154 (and which may optionally have passed through other optical elements such as optical windows).

Filtered light 132 is incident on beamsplitter assembly 154. Beamsplitter assembly 154 includes a dichroic beamsplitter 110, and controller 122 can selectively position dichroic beamsplitter 110 in the path of filtered light 132 by transmitting a suitable control signal to beamsplitter assembly 154. During operation of system 100 to obtain an image of sample 10, dichroic beamsplitter 110 is ordinarily positioned in the path of filtered light 132.

To obtain a fluorescence image of sample 10, filtered light 132—after passing through dichroic beamsplitter 110—is incident on sample 10. In general, filtered light 132 excites one or more fluorescent moieties present in the sample. The fluorescent moieties generate fluorescence emission light 134, a portion of which propagates in the −z direction toward dichroic beamsplitter 110. The spectral properties of dichroic beamsplitter 110 are generally chosen such that dichroic beamsplitter 110 allows light of certain wavelengths (e.g., filtered light 132) to pass through, and reflects light within other wavelength bands (e.g., fluorescence emission light 134). Consequently, fluorescence emission light 134 is reflected by dichroic beamsplitter 110 and is incident on emission filter assembly 156.

Emission filter assembly 156—which is optional—typically includes one or more emission filters 116. Controller 122 can generally select the emission filter 116 (or combination of emission filters 116) that are positioned in the path of fluorescence emission light 134. One or more emission filters 116 are typically used to allow fluorescence emission light 134 within a particular spectral band or plurality of bands to reach detector 120, and to prevent fluorescence emission light 134 and other light (e.g., stray light, filtered light 132) from reaching detector 120.

Detection light 136 emerges from emission filter assembly 156 and passes through imaging lens 118, which forms an image of sample 10 at an image plane. In general, detector 120 includes a sensing element (or multiple sensing elements) positioned at or near the image plane, and captures an image of sample 10 by detecting detection light 136. The image can correspond to the entirety of sample 10 or to only a portion of sample 10, depending upon the region of the sample 10 upon which filtered light 132 is incident. In general, sample 10 is located at or near an object plane of system 100, and detector 120 is located at or near an image plane of system 100. The combined effect of objective lens 104, dichroic beamsplitter 110, and imaging lens 118 is to image light (e.g., fluorescence emission light 134) from the system's object plane onto the system's image plane.

To obtain an image of the specimen in sample 10, the sample is generally positioned such that the upper surface of coverslip 150 (i.e., the surface of the coverslip that does not face the specimen, and faces objective lens 104) lies in the system's object plane z_{obj}. In this configuration, the object plane of the system is positioned at a distance f_{obj} along the z-direction from objective lens 104, where f_{obj} is the nominal focal length of objective lens 104.

Illumination source 102 can be implemented as a wide variety of different sources, including incandescent, fluorescent, diode-based, and laser-based sources. Illumination source 102 can include wavelength modulating elements such as filters to adjust the spectral distribution of illumination light 130.

Objective lens 104 can be a single or compound lens, and can include one or more spherical and/or aspherical surfaces. Although shown as a transmissive lens in FIG. 1, objective lens 104 can also be implemented as a reflective lens. In some embodiments, objective lens 104 can be an infinity-corrected lens, i.e., an infinite-conjugate lens. Objective lens 104—whether containing a single lens element or multiple lens elements—effectively forms a projection objective of system 100.

Imaging lens 118 can be a single or compound lens, and can include one or more spherical and/or aspherical surfaces. Imaging lens 118 can be a transmissive lens as shown in FIG. 1, or alternatively, a reflective lens. In certain embodiments, imaging lens 118 can be implemented as a tube lens that includes multiple transmissive and/or reflective elements.

In addition to the elements discussed above, system 100 can also generally include a wide variety of other optical elements including, but not limited to, lenses, mirrors, beamsplitters, filters, polarization optics, windows, prisms, and gratings.

Detector 120 includes a two-dimensional imaging sensor that captures images of sample 10 (and/or objects positioned on stage 114). Any one or more of a wide variety of imaging sensors can be include in detector 120. For example, detector 120 can include CCD-based sensors, CMOS-based sensors, diode-based sensors, and other imaging sensors.

Controller 122 includes a display interface 124 upon which the controller can display images acquired by detector 120, user interface information, operating parameters, and other information. Input interface 126 (which can be implemented as part of display interface 124) allows a user of system 100 to enter commands, set operating parameters, adjust or select system configurations, and control other aspects of the operation of system 100.

Electronic processor 128 (which can be implemented as a single processor or a plurality of processors that perform common or different functions) performs a variety of different system control and calculation functions. In general, through electronic processor 128, controller 120 can perform any of the configuration, operation, imaging, and analysis steps disclosed herein. Controller 122 (and electronic processor 128) is connected to illumination source 102, to stage 114, to detector 120, to excitation filter assembly 152, to beamsplitter assembly 154, and to emission filter assembly 156.

Controller 122 can transmit various control signals to illumination source 102 to adjust various properties of illumination light 130, including the intensity, wavelength, polarization state, and spatial intensity profile of the light. Controller 122 can transmit control signals to stage 114 to translate stage 114 in any one or more of the x-, y-, and z-directions. Thus, for example, to change the relative distance between objective lens 104 and stage 114 along the z-direction, controller 122 can transmit control signals to stage 114, which effects translation of sample 10 in the +z or −z directions, as desired.

It should be noted that in the description herein, controller 122 transmits control signals to stage 114 to translate stage 114 in a direction parallel to the z-axis to adjust the position of stage 144 and sample 10 relative to the system's object plane z_{obj}. In some embodiments, in addition to or as an alternative to translating stage 114, objective lens 104 can be translated in a direction parallel to the z-axis to adjust the location of the system's object plane along the z-axis. In practice, adjusting the position of objective lens 104 may also change the distance between patterned modulator 108 and objective lens 104, and this change is reflected in the value of d₁ (discussed in further detail below). While the discussion below discusses only adjustments to the z-coordinate location of stage 114, it should be understood that adjustments to the z-coordinate location of objective 104, and/or to the locations of both stage 114 and objective 104, can be implemented in the methods described herein, without loss of functionality or applicability.

Image information captured by detector 120 is transmitted to controller 122. The image information can be analyzed as will be discussed in greater detail below by electronic processor 128 to determine whether the surface of the coverslip of sample 10 is located in the object plane of system 100, and to determine an appropriate adjustment of the position of sample 10 relative to objective lens 104 if the surface of the coverslip is not located in the system's object plane.

In general, the position of sample 10 relative to the system's object plane—and any correction to account for a displacement of sample 10 from the object plane—can be determined at any point in a sequence of operations to obtain one or more sample images. In some embodiments, for example, the position of sample 10 relative to the object plane can be determined/corrected prior to obtaining any sample images. In certain embodiments, the position of sample 10 can be determined/corrected after obtaining one or more images, but before obtaining additional images. In some embodiments, the position of sample 10 can be determined/corrected after obtaining one or more lower resolution images, but prior to obtaining one or more higher resolution images of the sample. In certain embodiments, the position of sample 10 can be determine/corrected after imaging a first portion of the specimen, but prior to imaging one or more additional portions of the specimen, e.g., after translating sample 10 in one or both of the x- and y-directions.

To determine the position of sample 10—and in particular, the position of the upper surface of the coverslip of sample 10—relative to the system's object plane z_{obj}, the configuration of the optical elements in system 100 is typically changed. In particular, patterned modulator 108 is introduced into the path of illumination light 130 or filtered light 132 upstream from beamsplitter assembly 154, and dichroic beamsplitter 110 is replaced with a partially transmissive, partially reflective beamsplitter 112. In general, patterned modulator 108 can be positioned at any location between illumination source 102 and the beamsplitter. In some embodiments, the excitation filter 106 (or filters 106) are removed from system 100 and the patterned modulator is inserted at the former location of the excitation filter(s) 106. In certain embodiments, the excitation filter(s) 106 remain in system 100, and the patterned modulator is inserted either upstream or downstream from the filter(s), and upstream from the system's object plane. Insertion of the patterned modulator and/or removal of the excitation filter(s) 106 can be performed manually or in automated fashion.

As noted above, partially transmissive beamsplitter 112 is generally inserted in system 100 at the location of dichroic beamsplitter 110, which is removed. As above, removal of dichroic beamsplitter 110 and/or insertion of the partially transmissive beamsplitter 112 can generally be performed manually or in automated fashion.

The patterned modulator 108 typically contains a pattern of features that modulate the intensity of illumination light 130 or filtered light 132. The patterned modulator can be formed in various ways, and can generally be implemented as an active or passive modulator, or alternatively, can include both active and passive components that modulate the intensity of light that is incident on the modulator. In some embodiments, for example, the patterned modulator 108 consists of a plurality of metallic or other non-transmissive features arranged in a pattern on a substrate such as an optical window. The features allow a portion of illumination light 130 or filtered light 132 to pass through the substrate, and block a portion of the illumination or filtered light, thereby imparting a modulation to the cross-sectional spatial intensity profile of the illumination or filtered light.

In certain embodiments, the patterned modulator 108 includes one or more diffractive elements that impart a modulation to the cross-sectional spatial intensity profile of the illumination or filtered light. In some embodiments, the patterned modulator 108 includes one or more apertures formed in a light-blocking substrate, which collectively impart a modulation to the cross-sectional spatial intensity profile of the illumination or filtered light before the light reaches the system's object plane. In certain embodiments, the patterned modulator 108 is an adjustable modulator (e.g., such as a liquid crystal-based spatial light modulator) that can be configured to impart any of a variety of different modulations to the cross-sectional spatial intensity profile of the illumination or filtered light.

As an example, in some embodiments, the patterned modulator is implemented as a reticle, such as a chrome reticle. Chrome reticle R1DS2N (available from Thorlabs, Newton, NJ) is an example of a suitable chrome reticle for use as patterned modulator 108.

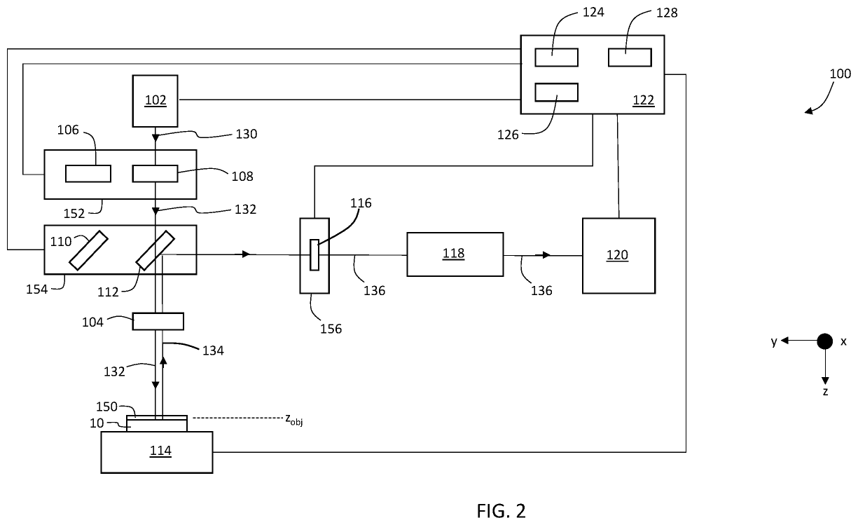

FIG. 2 is a schematic diagram of the optical microscope system 100 after patterned modulator 108 and partially transmissive beamsplitter 112 have been introduced. In the example shown in FIG. 2, controller 122 has transmitted a control signal to excitation filter assembly 152 to remove excitation filter 106 from the path of illumination light 130 and to introduce patterned modulator 108 into the path of the illumination light. In addition, controller 122 has transmitted a control signal to beamsplitter assembly 154 to remove dichroic beamsplitter 110 from the path of filtered light 132 and to introduce partially transmissive beamsplitter 112 into the path of the filtered light.

In some embodiments, emission filter assembly 156 can include a specialized filter that blocks stray light that is not used to form the image of the patterned modulator on the sensor(s) of detector 120. The specialized filter can be introduced into the path of the light reflected from partially transmissive beamsplitter 112 to block the stray light. As with partially transmissive beamsplitter 112 and/or patterned modulator 108, the specialized filter can be introduced into system 100 manually, or in automated fashion via a control signal transmitted from controller 122 to emission filter assembly 156.

System 100 is an example of a system in which the patterned modulator and partially transmissive beamsplitter (and optionally, the stray light filter) are introduced in automated fashion. Excitation filter assembly 152 (which can be implemented, for example, as a motorized or actuated filter wheel) includes patterned modulator 108. Controller 122 can transmit a suitable control signal to excitation filter assembly 152 to remove any excitation filter(s) 106 in the path of illumination light 130 and instead insert patterned modulator 108 at the location previously occupied by the excitation filter(s). As such, illumination light 130 is no longer spectrally filtered by excitation filter assembly 152. Instead, the cross-sectional spatial intensity profile of illumination light 130 is modulated by patterned modulator 108, such that filtered light 132 carries a spatial pattern in the form of a cross-sectional spatial intensity modulation.

In general, the image of patterned modulator 108 is formed in a plane that is a distance ΔD beyond the system's object plane. Accordingly, because the optical path in system 100 is folded (i.e., the image of patterned modulator 108 is captured in reflection mode), when the upper surface of the coverslip of sample 10 is located at a distance ΔD/2 beyond the system's object plane, an image of patterned modulator 108 is formed, after reflection from the upper surface of the coverslip, in the system's object plane. With the upper surface of the coverslip positioned as described above, the spatial pattern carried by filtered light 132 is imaged onto the upper surface of the coverslip 150, and a portion of the filtered light 132 reflects from the upper surface of the coverslip 150 as if the spatial pattern originated from the upper surface of the coverslip. Nominally, the image of the spatial pattern is imaged in focus at the system's image plane, and therefore the spatial pattern appears in focus in the image captured by detector 120 at the system's image plane. However, when the upper surface of the coverslip of sample 10 is displaced from the above-described position, the spatial pattern that is reflected from the upper surface of the coverslip—at the position of the upper surface of the coverslip—is not perfectly in focus. Consequently, the image of the spatial pattern that is obtained by detector 120 at the image plane is also not perfectly in focus.

With patterned modulator 108 and partially transmissive beamsplitter 112 positioned in the path of illumination light 130 and filtered light 132 as shown in FIG. 2, an image of patterned modulator 108 is projected at a distance d₁ from objective lens 104, where d₁ is related to the nominal focal length f_{obj} of objective lens 104 and to the distance d₂ between patterned modulator 108 and objective lens 104 along the z-direction according to the lens equation:

$$1 / {f}_{obj} = 1 / {d}_{1} + 1 / {d}_{2} \qquad [ 1 ]$$

For an objective lens 104 at infinite conjugate (as described above in connection with objective lens 104), the image obtained at the system's image plane will be in focus if the object (i.e., the image of patterned modulator 108 formed by objective lens 104) is in focus at the system's object plane. For the system shown in FIG. 2, the projected image of patterned modulator 108 is located at a distance ΔD from the system's object plane:

$${d}_{1} = {f}_{obj} + Δ D = 1 / [ 1 / {f}_{obj} - 1 / {d}_{2} ] - 1 / {f}_{obj} \qquad [ 2 ]$$

As a result, when the projected image of patterned modulator 108 is located at a distance from objective lens 104 that is not d₁, the image of patterned modulator 108 obtained with detector 120 positioned in the system's image plane will not be in focus. However, if stage 114 is translated in the z-direction such that the upper surface of the coverslip—from which the projected image of patterned modulator 108 reflects—is positioned such that the image of patterned modulator 108 formed by objective lens 104 is positioned a distance d₁ along the optical path from objective lens 104, the image of patterned modulator 108 obtained with detector 120 positioned in the system's image plane will be in focus. Referring to Equation (2) above, and noting that the system's optical path is folded between partially transmissive beamsplitter 112 and stage 114, the image of patterned modulator 108 formed by objective lens 104 will be in focus on the system's object plane after reflecting from the upper surface of the coverslip if the upper surface of the coverslip is positioned at a distance ΔD/2 from the object plane of the system.

Consequently, by assessing the extent to which the image of patterned modulator 108 is in focus or out of focus in an image obtained in the system's image plane, the position of the upper surface of the coverslip relative to the system's object plane can be estimated. Moreover, a corrective displacement can be determined for any particular position of the upper surface of the coverslip of sample 10 along the z-direction to ensure that the upper surface of the coverslip is positioned such that the image of patterned modulator 108 formed by objective lens 104 is formed in the system's object plane.

To position the upper surface of the coverslip 150 of sample 10 at a particular z-coordinate location relative to the system's object plane, a plurality of different images can be obtained, each with patterned modulator 108 and partially transmissive beamsplitter 112 positioned within the optical path of the system as discussed above in connection with FIG. 1. Each of the different images corresponds to a different relative displacement between objective lens 104 and the upper surface of the coverslip. Prior to obtaining each image, controller 122 translates sample 10 along the z-direction by transmitting suitable control signals to stage 114, thereby selecting a different relative displacement.

The set of relative displacements is typically selected such that the set of displacements includes sample positions for which the optical path length between objective lens 104 and the system's object plane for light reflected from the upper surface of the coverslip is greater than d₁ and less than d₁. For each relative displacement, an image is obtained. The resulting set of images is analyzed and the image in which the modulation pattern imparted by patterned modulator 108 is in best focus is designated as the focused image. This focused image, as explained above, is obtained when the upper surface of the coverslip is positioned such that the distance along the optical path of system 100 between objective lens 104 and the system's object plane, after reflection from the upper surface of the coverslip, is d₁.

After one or more images of light modulated by patterned modulator 108 (or one or more images of feature on a coverslip or slide) have been obtained, the images can be analyzed to determine which image or images correspond to a “best-focus” condition using a variety of different methods. For example, in some embodiments, the images are analyzed by determining a maximum and minimum pixel intensity in each image, and then calculating the difference between the maximum and minimum pixel intensity to yield a contrast metric. Among a set of images, the images with the highest contrast metric (i.e., the largest difference between maximum and minimum pixel intensities) may be determined to represent the “best-focus” condition. The maximum and/or minimum pixel intensities may be determined from a single pixel intensity, or may be averaged over a group of pixels (e.g., averaged over n largest or smallest pixel intensities, where n is two or more, three or more, five or more, 10 or more, 20 or more, 30 or more, 50 or more, or even more).

In certain embodiments, the images are analyzed by selecting one or more features that appear in each of the images, and calculating a spatial rate of change of intensity along one or more pixel rows or columns that traverse the one or more features. In general, for an image that is closer to a “best-focus” condition, transitions between light and dark regions in the image will be more abrupt; that is, the rate of change of intensity across such transitions will be larger. As such, the rate of change of intensity along one or more common pixel rows or columns in each of the images can function as a metric to determine which of the images corresponds to the “best-focus” condition.

Other methods can also be used in addition to, or as alternatives to, the foregoing methods. Examples of methods and metrics such as F-score are described in Bray et al., J Biomol. Screen 17(2): 266-274 (2012), the entire contents of which are incorporated herein by reference.

It should be noted that in some embodiments, when no single image of the pattern of modulator 108 is in perfect focus at the image plane of the system, the best focus z-coordinate of stage 114 is likely a coordinate position that is intermediate between two of the z-coordinate positions used to generate the two images that are closest to being in perfect focus. Under these circumstances, the z-coordinate representing the best focus can be determined by interpolating between the z-coordinate positions used to generate the two images that are closest to being in perfect focus.

As shown by Equation (2) above, controller 122 can then re-position sample 10 such that the upper surface of the coverslip is located in the system's object plane (i.e., at a distance f_{obj} from objective lens 104) by translating stage 114 a distance of ΔD/2 along the z-direction.

After sample 10 has been re-positioned such that the upper surface of the coverslip is located in the system's object plane, one or more multispectral images (e.g., fluorescence images) of the sample can be obtained. To obtain such images, controller 122 transmits suitable control signals to excitation filter assembly 152 to remove patterned modulator 108 from the path of illumination light 130 (and optionally, to insert any desired excitation filters 106 into the path). Controller 122 also transmits suitable control signals to beamsplitter assembly 154 to remove partially transmissive beamsplitter 112 from the path of filtered light 132, and to insert dichroic beamsplitter 110 into the path of filtered light 132.

As discussed above, filtered light 132 is directed onto sample 10, and fluorescence emission light 134 generated by sample 10 propagates in the −z direction, is reflected by dichroic beamsplitter 110 and enters emission filter 116 (or a combination of emission filters 116) in emission filter assembly 156. Detection light 136 emerges from emission filter assembly 156, passes through imaging lens 118, and forms an image of sample 10 at the image plane of system 100 where the sensing element(s) of detector 120 is/are positioned. Detection 120 captures image information by detecting detection light 136, and the image information is transmitted to controller 122. Multiple images of sample 10 can be obtained by using different combinations of excitation filter(s) 106 and/or emission filter(s) 116.

### Calibration of Microscope Systems

In the foregoing example, it is assumed that the distance ΔD is already known, for example from previously measured calibration information and/or system design information (e.g., computed from Equation (2)). As a result, controller 122 can use the known value of ΔD to reproducibly re-position sample 10 such that the upper surface of the coverslip is located in the system's object plane.

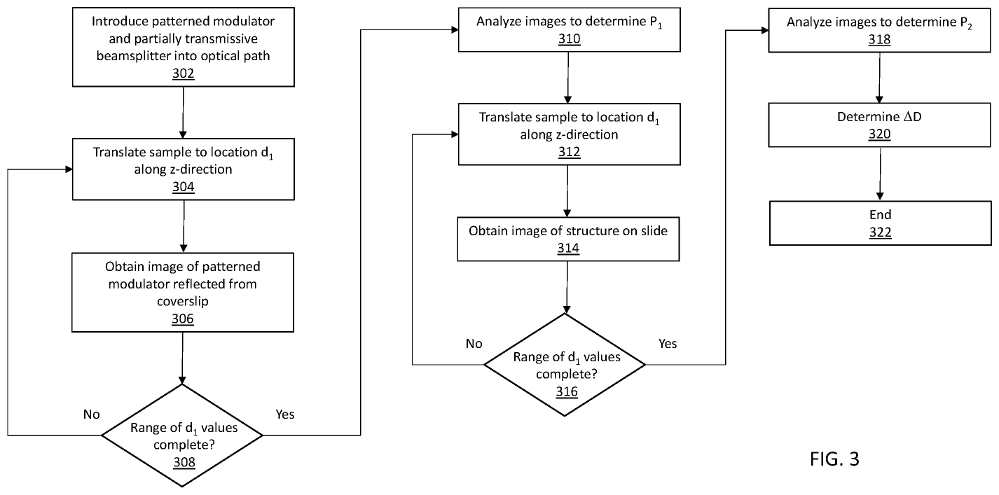

Alternatively, the quantity ΔD can be determined from a calibration procedure that is performed as part of a sample imaging workflow. Various methods can be used to perform such a calibration. FIG. 3 is a flow chart showing a series of example steps for performing the calibration procedure.

At a first step 302 of the calibration procedure, patterned modulator 108 and partially transmissive beamsplitter 112 are introduced into system 100 as discussed above, and a sample 10 is positioned on stage 114.

Next, at step 304, stage 114 is activated to translate sample 10 along the z-direction to a specific location on the z-axis that corresponds to a particular distance d₁. At step 306, an image of the patterned modulator 108 reflected from the surface of the coverslip is obtained.

Then, at step 308, if images at a suitable range of distances d₁ have not been obtained, control returns to step 304 and stage 114 is activated to translate sample 10 to a new location on the z-axis. Alternatively, if images at a suitable range of distances d₁ have been obtained, the set of images is then analyzed at step 310 to determine the z-axis coordinate of stage 114 at which the image of patterned modulator 112 is at best focus. This stage position is designated P₁, and corresponds to the upper surface of the coverslip being displaced from the system's object plane by a distance ΔD/2.

Next, at step 312, stage 114 is activated to translate sample 10 along the z-direction to a specific location on the z-axis that is part of a second range of distances d₁. The second range of distances is generally selected such that the specimen between the coverslip 150 and slide will be positioned in the system's object plane at one of the z-axis positions in the second range of distances.

Then, at step 314, an image of a structure on the slide is obtained. The structure can, for example, be a fiducial mark, a debris particle, a specimen structure, or any other feature that is at or in contact with the surface of the slide that faces the coverslip.

Next, at step 316, if images at a suitable second range of distances d₁ have not been obtained, control returns to step 312 and stage 114 is activated to translate sample 10 to a new location on the z-axis. Alternatively, if images at a suitable range of distances d₁ have been obtained, the set of images is then analyzed at step 318 to determine the z-axis coordinate of stage 114 at which the image of the structure on the slide is at best focus. This stage position is designated P₂, and corresponds to the surface of the slide being positioned in the system's object plane.

The quantity ΔD is then determined in step 320 by the difference between the stage positions (P₂−P₁) and the location of the structure relative to the surface of the slide. In practice, it is possible to first calibrate the quantity ΔD between the modulator pattern being in focus and the upper surface of the coverslip, and then separately determine the offset between the upper surface of the coverslip and the expected sample position. Performing the calibration in this manner has the benefit that ΔD is independent of the sample thickness. As such, when ΔD is calibrated independently of the offset between the upper surface of the coverslip and the expected sample position, the same calibrated value of ΔD can be used when imaging samples of different thickness. Only the offset is calibrated for such samples when they are introduced into the system. The procedure shown in FIG. 3 then ends at step 322.

### Focus Mapping

In some embodiments, the system calibration (i.e., measurement or a priori knowledge of ΔD) can be used to perform focus mapping for a sample 10. As used herein, focus mapping refers to a process of determining, as a function of x- and y-coordinate locations, at set of z-coordinate locations for sample 10 at which the specimen sandwiched between the sample's coverslip and slide is at best focus. Because specimens are routinely non-uniformly thick and can introduce a variety of imaging errors and artifacts, in general not all portions of a specimen in the lateral (x,y) plane will appear in focus at a common z-coordinate position of the specimen (and stage 114). Instead, at different (x,y) locations, the z-coordinate position representing best focus for the portion of the specimen at the different (x,y) locations will typically differ. Focus mapping is a procedure in which a set of z-coordinate positions representing the best focus for the specimen as a function of (x,y) location is determined.

To perform focus mapping, an initial z-coordinate value Z_{c} is determined from the position of best focus of the reflected image of patterned modulator 108 and the value of ΔD, as described above. The z-coordinate value Z_{c} represents the z-coordinate value at which the surface of the coverslip is located in the object plane of system 100.

The patterned modulator 108 and partially transmissive beamsplitter 112 are then removed from system 100 and dichroic beamsplitter 110 is re-introduced into system 100.

Next, a range of z-coordinate values at which stage 114 will be positioned to determine the location of best focus at each (x,y) location of the specimen is determined. In some embodiments, Z_{c} represents a limit on one side of the range of z-coordinate values, since the specimen is always positioned at a more positive z-coordinate location than the surface of the coverslip.

Then, the focus map is measured. At each one of a set of discrete (x,y) locations in the specimen, stage 114 is translated through the range of z-coordinate values in discrete steps. After each successive discrete step translation of stage 114, an image of the specimen is obtained.

The set of images obtained via translation of stage 114 through the range of z-coordinate values is then analyzed to determine which image of the set is in best focus. The corresponding z-coordinate value of stage 114 that is associated with the image of best focus at location (x,y), designated Zₛ(x,y), can then be stored as an entry in the focus map for sample 10. Alternatively, the z-coordinate value of stage 114 that represents the position of best focus, Zₛ(x,y), can be calculated by interpolating between two z-coordinate values of stage 114, each of which corresponds to an image that is nearly best-focused.

The foregoing process can be repeated at multiple (x,y) locations in the specimen to yield a set of best focus values for the specimen, Zₛ(x,y), which constitutes the focus map for sample 10.

### Slide Position Determination

In some embodiments, a procedure similar to the one described for the coverslip can be used to determine the z-coordinate position of stage 114 at which the bottom surface of the slide of sample 10 is in the object plane of system 100. As used herein, the “bottom surface” of the slide is the slide surface that nearest to and/or contacts stage 114, and is opposite to the slide surface that contacts the specimen of sample 10.

The procedure for determining the z-coordinate position of stage 114 at which the bottom surface of the slide of sample 10 is in the object plane of system 100 can include steps that are similar to the steps described above in connection with FIG. 3. In a first step, patterned modulator 108 and partially transmissive beamsplitter 112 are introduced into system 100 as described above.

Then, a range of z-coordinate values of stage 114 is determined. In general, the range includes one or more z-coordinate values such that if stage 114 was positioned at any of the one or more z-coordinate values, the bottom surface of the slide would be displaced in the +z direction relative to the system's object plane, and one or more z-coordinate values such that if stage 114 was positioned at any of those one or more z-coordinate values the bottom surface of the slide would be displaced in the −z direction relative to the system's object plane.

Next, stage 114 is successively translated to each of the z-coordinate values within the range, and at each z-coordinate value, an image of patterned modulator 108 is obtained.

The set of images obtained in this matter is then analyzed to determine which image in the set provides a best-focus image of patterned modulator 108. The z-coordinate value associated with this image is designated Zᵤ, the z-coordinate value at which the bottom surface of the slide is located at a distance ΔD/2n beyond the system's object plane, where n is the refractive index of the material from which the slide is formed.

In some embodiments, the foregoing procedure can be used to determine whether a sample 10 that is introduced onto stage 114 is at an expected position. For example, after a sample is positioned on stage 114, stage 114 can be translated through the range of z-coordinate values described above. Projected images of patterned module 108 can be analyzed to determine the actual z-coordinate value, Zᵤ, at which the bottom surface of the slide is located in the system's object plane. The measured Zᵤ value can be compared for example to a calibrated or standardized value for Zᵤ to determine whether the sample's slide is positioned at an expected location in system 100, or displaced from the expected location. The foregoing method can be used, for example, to check that the slide is seated properly in system 100 prior to obtaining images of the specimen.

### Specimens and Sample Types

The systems and methods described herein can be used to obtain images of a wide variety of different specimens sandwiched between a slide and a coverslip for multispectral imaging. Such specimens include, but are not limited to, tissues, core biopsies, cell cultures, tissue sections (e.g., formalin-fixed paraffin-embedded sections), fine-needle aspirates, individual cells and groups of multiple cells, and smears of blood and other body fluids.

### Hardware and Software Implementations

Any of the steps disclosed herein can be executed by controller 122 (e.g., by electronic processor 128 of controller 122) and/or one or more additional electronic processors (such as computers or preprogrammed integrated circuits) executing programs based on standard programming techniques. Such programs are designed to execute on programmable computing apparatus or specifically designed integrated circuits. Controller 122 can include a data storage system (including memory and/or storage elements), at least one input device such as input interface 126, and at least one output device, such as a display interface 124, to which controller 122 is linked.

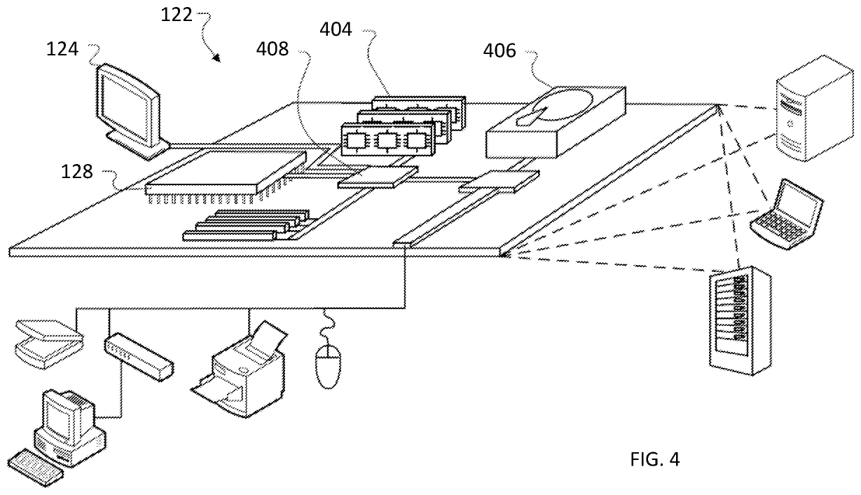

FIG. 4 is a schematic diagram of an example of controller 122 that can be present in the systems described herein, and can perform any of the method steps described herein. Controller 122 can include one or more processors 128, memory 404, a storage device 406 and interfaces 408 for interconnection. The processor(s) 128 can process instructions for execution within the controller, including instructions stored in the memory 404 or on the storage device 406. For example, the instructions can instruct the processor(s) 128 to perform any of the steps disclosed herein.

The memory 404 can store executable instructions for processor(s) 128, information about parameters of the system such as excitation and detection wavelengths, measured image information, and/or calibration information. The storage device 406 can be a computer-readable medium, such as a floppy disk device, a hard disk device, an optical disk device, or a tape device, a flash memory or other similar solid state memory device, or an array of devices, including devices in a storage area network or other configurations. The storage device 406 can store instructions that can be executed by processor(s) 128 as described above, and any of the other information that can be stored by memory 404.

In some embodiments, controller 122 can include a graphics processing unit to display graphical information (e.g., using a GUI or text interface) on an external input/output device, such as display interface 124. The graphical information can be displayed by a display device (e.g., a CRT (cathode ray tube) or LCD (liquid crystal display) monitor) for displaying any of the information, such as measured and calculated spectra and images, disclosed herein. A user can use input devices (e.g., keyboard, pointing device, touch screen, speech recognition device) to provide input to controller 122. In some embodiments, one or more such devices can be part of controller 122.

A user of system 100 can provide a variety of different types of instructions and information to controller 122 via input devices. The instructions and information can include, for example, information about any of the wavelengths, filters, and physical parameters (e.g., focal lengths, positions of components of system 100) associated with any of the workflows described herein, and calibration information for the system. Controller 122 can use any of these various types of information to perform the methods and functions described herein. It should also be noted that any of these types of information can be stored (e.g., in storage device 406) and recalled when needed by controller 122.

The methods disclosed herein can be implemented by controller 122 executing instructions in one or more computer programs that are executable and/or interpretable by the controller 122. These computer programs (also known as programs, software, software applications or code) include machine instructions for a programmable processor, and can be implemented in a high-level procedural and/or object-oriented programming language, and/or in assembly/machine language. For example, computer programs can contain the instructions that can be stored in memory 404, in storage unit 406, and/or on a tangible, computer-readable medium, and executed by processor(s) 128 as described above. As used herein, the term “computer-readable medium” refers to any computer program product, apparatus and/or device (e.g., magnetic discs, optical disks, memory, Programmable Logic Devices (PLDs), ASICs, and electronic circuitry) used to provide machine instructions and/or data to a programmable processor, including a machine-readable medium that receives machine instructions.

By executing instructions as described above (which can optionally be part of controller 122), the controller can be configured to implement any one or more of the various steps described in connection with any of the workflows herein. For example, controller 122 can adjust positions of any of the components of system 100, obtain images as described herein, analyze the obtained images, and adjust system 100 based on the analysis (e.g., calibration information derived from the analysis).

### Examples

A system similar to the systems described herein was constructed as follows. An Olympus BX-43 microscope was outfitted with BX3 fluorescent illumination optics in an 8-position filter wheel. Objective lens 104 was an Olympus 10×UPLXAPO. The optical elements used for forming an image of the patterned modulator were housed in an epi-filter cube, placed in position 8 of the filter wheel, and included: a chrome reticle (reticle R1DS2N, obtained from Thorlabs, Newton, NJ) in the excitation filter location; a partially transmissive, neutral density 50/50 beamsplitter in the dichroic beamsplitter location, and a red filter in the emission filter location (Semrock FF01-637-7-25).

The system was operated at infinite conjugate, and the objective lens had a focal length of 18 mm. The distance d₂ from the objective lens to the reticle was approximately 139 mm. The projected image was formed at ΔD=2680 microns past the nominal system object plane. Light from the illumination source reflected from the top of the coverslip and formed an image in free space.

When the coverslip was approximately ΔD/2 past the plane that formed an image at the imaging sensor, then the projected image, after reflection, was formed exactly at that plane. When the coverslip was moved toward or away from the objective lens by a small amount, the reflected image was moved toward or away by twice that amount due to the reflective geometry. In the system constructed, an image of the patterned target was formed at the imaging sensor when the coverslip was approximately 1340 microns beyond the conventional imaging plane.

The projected image could be observed by placing a white target 2680 microns past the conventional imaging plane. Making a measurement of this kind is one way to measure ΔD. However, in this configuration the image is formed at a location that is not a conjugate plane to the imaging sensor, so the imaging sensor cannot assess best focus. In another approach, a microscope slide was used to form the projected image in space, at the conventional system image plane.

A piece of glass with patterned chrome features was placed on the stage and the epi-filter wheel was set to engage the patterned target and partially reflective beam splitter. A set of images was taken with the stage at a range of locations that spanned the location that put the patterned surface 1340 microns past the normal object plane. This range spanned +/−500 microns around that point, to allow for uncertainty in the stage position, the thickness of the glass, and other factors. These images were analyzed, and the best-focus location Zᵣ was determined by measurement of normalized variance in each image. Images were taken at 10-micron intervals, and the 3 positions corresponding to the images at which focus was best were fitted to interpolate the position of best-focus with finer resolution.

The epi-filter was set to remove all elements from the beam and transmitted-light brightfield images were obtained while the stage was set to a range of locations spanning the location that puts the patterned surface at the normal system object plane. This range spanned +/−500 microns or more, for similar reasons to those just noted. These images were examined and the best focus location Zₜ was found by the same methods just described. Based on these measurements, the system was calibrated according to:

$$Δ D / 2 = {Z}_{t} - {Z}_{r} \qquad [ 3 ]$$

For the present system, ΔD/2=1340 microns.

In operation, the epi-filter wheel was set to engage the patterned optics, and the system found the stage location corresponding to best focus for the projected image of the patterned target. The surface of the coverslip was in focus when the stage was set 1340 microns closer to the objective than that point.

### Other Embodiments

While this disclosure describes specific implementations, these should not be construed as limitations on the scope of the disclosure, but rather as descriptions of features in certain embodiments. Features that are described in the context of separate embodiments can also generally be implemented in combination in a single embodiment. Conversely, various features that are described in the context of a single embodiment can also be implemented in multiple embodiments separately or in any suitable sub-combination. Moreover, although features may be described above as present in certain combinations and even initially claimed as such, one or more features from a claimed combination can generally be excised from the combination, and the claimed combination may be directed to a sub-combination or variation of a sub-combination.

In addition to the embodiments expressly disclosed herein, it will be understood that various modifications to the embodiments described may be made without departing from the spirit and scope of the disclosure. Accordingly, other embodiments are within the scope of the following claims.

What is claimed is:

1. A method, comprising:
generating a modulated light pattern using a light modulator;
transmitting the modulated light pattern through an objective lens to a surface of a substrate, wherein the objective lens defines an object plane;
obtaining a plurality of images of the modulated light pattern reflected from a surface of a substrate, wherein each modulated light pattern is obtained at a different relative distance between the objective lens and the substrate surface;
analyzing the plurality of images to determine a reference location of the substrate surface relative to the objective lens that corresponds to positioning of an image of the modulated light pattern formed by the objective lens at the object plane; and
adjusting a position of the substrate relative to the objective lens based on the reference location.

2. The method of claim 1, wherein the substrate comprises a coverslip that overlies a biological sample.

3. The method of claim 1, wherein the substrate comprises a slide that supports a biological sample.

4. The method of claim 2, wherein the biological sample comprises a tissue section.

5. The method of claim 1, wherein generating the modulated light pattern comprises generating illumination light and transmitting illumination light through the light modulator.

6. The method of claim 1, wherein the light modulator is a passive modulator.

7. The method of claim 1, wherein the light modulator is an active modulator.

8. The method of claim 6, wherein the passive modulator comprises a reticle.

9. The method of claim 1, wherein each of the plurality of images is obtained by a detector positioned at an image plane that is conjugate to the object plane.

10. The method of claim 1, wherein the objective lens is an infinite-conjugate objective lens.

11. The method of claim 1, wherein analyzing the plurality of images comprises identifying an image among the plurality of images in which the modulated light pattern is in best focus.

12. The method of claim 11, wherein determining the reference location comprises identifying as the reference location a location of the substrate surface relative to the objective lens for which the identified image was obtained.

13. The method of claim 1, wherein analyzing the plurality of images comprises identifying two or more images among the plurality of images in which the modulated light pattern is in best focus, and determining the reference location comprises interpolating between locations of the substrate surface relative to the objective lens for which the identified images were obtained.

14. The method of claim 1, wherein adjusting a position of the substrate comprises adjusting the substrate position so that a biological sample positioned below or atop the substrate is located in the object plane.

15. The method of claim 14, further comprising obtaining one or more images of the biological sample with the biological sample located in the object plane.

16. A system, comprising:
an illumination source;
an objective lens;
a light modulator;
a detector;
a stage; and
a controller connected to the illumination source, the detector, and the stage,
wherein the objective lens defines an object plane of the system; and
wherein the controller is configured to:
activate the illumination source to generate illumination light and direct the illumination light to the light modulator to generate a modulated light pattern;
activate the stage to position a surface of a substrate on the stage at a plurality of different distances relative to the objective lens;
activate the detector to obtain images of the modulated light pattern at the detector corresponding to each of the plurality of different distances;
analyze the images to determine a reference location of the substrate surface relative to the objective lens that corresponds to positioning of an image of the modulated light pattern formed by the objective lens at the object plane; and
activate the stage to adjust a position of the substrate relative to the objective lens based on the reference location.

17. The system of claim 16, wherein the substrate comprises a coverslip that overlies a biological sample.

18. The system of claim 16, wherein the substrate comprises a slide that supports a biological sample.

19. The system of claim 17, wherein the biological sample comprises a tissue section.

20. The system of claim 16, wherein the light modulator is a passive modulator.

21. The system of claim 16, wherein the light modulator is an active modulator.

22. The system of claim 20, wherein the passive modulator comprises a reticle.

23. The system of claim 16, wherein the detector is positioned at an image plane of the system.

24. The system of claim 23, wherein the image plane is conjugate to the object plane.

25. The system of claim 16, wherein the objective lens is an infinite-conjugate objective lens.

26. The system of claim 16, wherein the controller is configured to analyze the images by identifying an image among the images in which the modulated light pattern is in best focus.

27. The system of claim 26, wherein the controller is configured to determine the reference location as a location of the substrate surface relative to the objective lens for which the identified image was obtained.

28. The system of claim 16, wherein the controller is configured to analyze the images by identifying two or more images among the images in which the modulated light pattern is in best focus, and to determine the reference location by interpolating between locations of the substrate surface relative to the objective lens for which the identified images were obtained.

29. The system of claim 16, wherein the controller is configured to activate the stage to adjust the position of the substrate so that a biological sample positioned below or atop the substrate is located in the object plane.

30. The system of claim 29, wherein the controller is configured to activate the detector to obtain one or more images of the biological sample with the biological sample located in the object plane.
